(19) United States
(12) Patent Application Publication
(10) Pub. No.: US 2008/0179563 A1
(43) Pub. Date: Jul. 31, 2008

(54) Radiator additive

(76) Inventor: Toshikuni Takashi, Tokyo (JP)

Correspondence Address: TOSHIKONI TAKASHI, # 101, 2-1-9 TAKANAWA, TOKYO, omitted

(21) Appl. No.: 11/699,001

(22) Filed: Jan. 29, 2007

(51) Int. Cl. C09K 5/00; F01P 11/00

(52) U.S. Cl. 252/71; 123/41.55

(57) ABSTRACT

To provide a radiator additive that supports the complete combustion of a mixture gas of air and fuel, thereby improving fuel efficiency and cleaning an exhaust gas. A radiator additive includes a composition of powders of a carbon-based semiconductor material and a rare-earth negative ion ore with a maximum particle size of the order of micrometers, and polypropylene glycol.

### FIELD OF THE INVENTION

The present invention relates to a radiator additive, and more specifically, to a radiator additive for improving fuel efficiency and reducing environmental loads, of an internal combustion engine.

### DESCRIPTION OF THE RELATED ART

Internal combustion engines of automobiles, etc. worsen fuel efficiency due to decrease in the pressure and compression of engine as well as cause various problems such as increase in unburned gas, decrease in power and occurrence of loud engine noises, as the years of use go by.

Although approaches of solving such problems have found uses of additives for gasoline, coating agents for air filters, etc., radiator additives are not present yet. Incidentally, search through technical documents, etc. on additives and coating agents of the above kind in Japan Patent Office found many documents on additives for gasoline and coating agents for air filters but was not made to be capable of finding documents on radiator additives.

Conventionally, addition of an additive to gasoline or application of a coating agent to an air filter has found a ratio of fuel or air or a mixture gas of fuel and air, optimal for combustion. Complete combustion of a mixture gas of these fuel and air adjusted leads to an improvement in fuel efficiency and cleaning of an exhaust gas.

For the complete combustion of gasoline (fuel), it is insufficient to study gasoline and air only. The quality of the environments (ambient atmosphere) within an engine combustion chamber for combusting a mixture gas of fuel and air is a large factor to determine the combustion of the mixture gas. In other words, a variety of experiments have revealed that the fact that the inside of the engine combustion chamber forms an atmosphere of supporting the combustion of the mixture gas leads to the complete combustion of the mixture gas, which allows the exhaust gas to be cleaned.

### SUMMARY OF THE INVENTION

The present invention has been made on the basis of findings via these various experiments, and negative ionization of the inside of an engine combustion chamber completely combusts a mixture gas of fuel and air.

According to a first aspect of the present invention, there is provided a radiator additive including a composition of powders of a carbon-based semiconductor material and a negative ion ore (rare earth, radioactive ore and substance having radioactive capacity equivalent thereto) with a maximum particle size of the order of micrometers, and polypropylene glycol.

According to a second aspect of the present invention, there is provided a radiator additive including a composition of a material produced by introducing a powder of a carbon-based semiconductor material with a particle size of the order of nanometers into water molecules to convert the mixture to a liquid, a powder of a rare-earth negative ion ore (rare earth, radioactive ore and substance having radioactive capacity equivalent thereto) with a particle size of the order of micrometers, and polypropylene glycol.

In the radiator additive described above, the carbon-based semiconductor material is an inorganic germanium-carbon; the negative ion ore is a rare-earth thorium ore; and the far-infrared emitting ore is pegmatite.

Since the radiator additive according to the present invention has a constitution as discussed above, introduction of the additive into a radiator causes the negative ionization of cooling water loaded in the radiator to proceed. In a circulation step of causing the cooling water in which negative ionization has proceeded to continuously circulate around an engine combustion chamber, the inside of the engine combustion chamber is gradually subjected to negative ionization. Then, as the negative ionization within the combustion chamber proceeds, the ionization degree of a mixture gas of gasoline and air introduced into the engine combustion chamber is enhanced and activated. This renders the mixture gas to be combusted and exploded in a substantially complete combustion state, thereby improving fuel efficiency and cleaning an exhaust gas.

### DESCRIPTION OF THE PREFERRED EMBODIMENTS

The present invention relates to a radiator additive for improving fuel efficiency of an internal combustion engine and cleaning an exhaust gas. Recently, many books and research papers by researchers have shown evidence that an increase in ionization degree of fuel and air molecules is effective in the improvement of fuel efficiency of an internal combustion engine and cleaning of an exhaust gas. However, practical applications of this evidence are extremely difficult and have not been put to practical use yet.

The present inventor has found by means of various experiments that the utilization of an inorganic germanium-carbon and a rare-earth negative ion ore powder with a particle size of the order of nanometers and micrometers, and the like, can expect large effects on the improvement in the fuel efficiency of an internal combustion engine and cleaning of the exhaust gas, and that addition of these to cooling water of a radiator for cooling the engine can maximally improve the fuel efficiency of the internal combustion engine, and the like. A radiator additive according to the present invention has been made on the basis of these findings.

Normally, a radiator is a cooling apparatus for only cooling an engine and does not originally have a function of improving fuel efficiency and cleaning of an exhaust gas. However, cooling water loaded into a radiator circulates at a high speed in the most immediate vicinity of an engine, and therefore, a large effect can be provided by stimulating a power source concentrated on the vicinity of an automobile by means of an additive for discharging negative ions via cooling water loaded into the radiator. Hence, the site of the radiator is the most appropriate place, i.e., the key position for maximally cleaning the exhaust gas.

Particularly, for a used car, the deterioration of an engine extremely worsens the fuel efficiency, so that metal ions (positive ions) may be generated in quantity. An increase in negative ions within cooling water or a coolant loaded in the radiator and an addition of an additive according to the invention having a function of decreasing plus ions thereto promote negative ionization within the radiator and engine combustion chamber regardless of running or stopping. This can enhance explosive power by means of the ionization reaction of air and fuel to improve fuel efficiency, clean an exhaust gas, remove noises, and increase power.

An additive according to the invention includes a composition prepared by converting a carbon-based semiconductor material, desirably, an inorganic germanium-carbon, to a nano liquid by nanotechnology, mixing therewith a strong ion powder ore, desirably, a rare-earth thorium ore with a particle size pulverized to about 1 to 5 micrometers, and further, as required, a negative ion powder with a large specific gravity, desirably, pegmatite (far-infrared emitting ore) with a particle size pulverized to 1 micrometer to 5 micrometers, and then mixing this composition with a solvent, desirably, polypropylene glycol.

### EXAMPLES

For an additive according to the present invention, one example of a composition for a V4 engine will be illustrated in the following. Additionally, for V6 and V8 engines, those contents are also desirably increased.

| | | |
|---|---|---|
| (1) | Material produced by colloid dissolving a powder of | about 5 cc |
| | an inorganic germanium-carbon in water to a colloid | |
| | (about 3200 ppm) | |
| (2) | Powder of rare-earth thorium ore (1 to 5 microns) | about 20 g |
| (3) | Powder of pegmatite (far-infrared emitting ore) (1 | about 10 g |
| | to 5 microns) | |
| (4) | Propylene glycol | about 100 cc |
| (5) | Other powders | |

Of the above components, (1) the material produced by colloid dissolving a powder of an inorganic germanium-carbon in water to a colloid is a metal ion, i.e., a substance that serves to reduce positive ions, and has a characteristic of discharging negative electron ions by increasing the temperature to 32° C. or higher. (2) The powder of rare-earth thorium ore and (3) the powder of pegmatite (far-infrared emitting ore) both serve to increase negative ions. (4) the polypropylene glycol has characteristics well soluble in water and alcohol, so that the above three materials are well soluble in propylene glycol.

Addition of this additive to the cooling water within a radiator has enabled the improvement in fuel efficiency of an internal combustion engine, cleaning of an exhaust gas, removal of noises, an increase in power, and the like of automobiles (both gasoline-fueled and diesel-fueled cars), ships, construction machinery, tanks, etc. In more detail, if the additive that serves to increase negative ions and decrease positive ions is added to the cooling water within the radiator, negative ionization within the radiator and an engine cylinder proceeds regardless of running or stopping. The progress of ionization within an engine enhances the explosion power of the mixture gas of air and fuel, maintains the conditions and aims at complete combustion. A deteriorated engine is remarkably recovered.

In other words, as time goes by week after week after the addition of the additive, the effect of the additive becomes larger. In about one month, the effect becomes maximal, and continues for 3 to 5 years. Introduction of the additive into a car when it is brand-new has a large effect on the prevention of the deterioration of the engine. For a used car, the fuel efficiency is extremely worsened due to deterioration of the engine, and metal ions (positive ions) may be generated in a large amount.

With such a used car, the water or coolant within the radiator is all withdrawn, and addition of the additive to new water or a coolant recovers the function of its engine when it was brand-new. The effect on the exhaust gas, etc. is better than the effect when it was brand-new. Although the improvement of fuel efficiency varies depending on the model of a car and deterioration conditions of an engine and is not constantly determined, a used car of a ten year old had an improvement of a fuel efficiency of about 30% in many cases. Additionally, the use of a powder with a particle size of the order of micrometers did not damage a water pump and a heat core within the radiator at all.

### Exhaust Gas Regulations of Automobiles in Japan

### Exhaust Gas Regulations of CO₂ for Automobiles are not Present in Japan

### [Exhaust Gas Testing]

Exhaust gas testing at Japan Automobile Transport Technology Association (JATA), Ministry of Land, Infrastructure and Transport Japan (MLTI Japan)

(A)-1

Tested Car: TOYOTA 1994 Model Camry

Date: For 48 hours, Jun. 27 to 29, 2005

No additive addition

After additive addition

(A)-2

Tested Car: TOYOTA 2003 Model Corolla

Date: For 7 days, May 14 to 24, 2005

No additive addition

After additive addition

Reduction of about 55% CO is a very large reduction, and normally, as the amount of CO is reduced, the amount of CO₂ is increased. In the testing this time, the amount of CO₂ hardly changed and was within the permissible range. Additionally, although tune-up was carried out on the tested car prior to the testing, the amount of CO was greatly reduced. The amount greatly cleared the emission standard of the year 2000.

The car of 1994 model cleared even the emission standard of the year 2000. Generally, the amount of reduction of CO is large. Although the amounts of HC and NOx are not greatly changed in a week, the effect would expect to gradually show up in two to 3 weeks.

[Fuel efficiency Testing]

Testing of fuel efficiency was conducted on about 30 car models of 6 car manufacturers. The improvement degree of fuel efficiency varies depending on a car manufacturer, the model of a car, and the deterioration degree of a car. Although the improvement degree of fuel efficiency is not constantly determined, particularly, for a used car of a ten year old, a fuel efficiency of about 30% or more was found in many cars.

(B)-1

Fuel efficiency tested car: TOYOTA Corolla 2000 Model

No additive addition

Place: Hawaii

Test Date: Jan. 2 to 22, 2004

Distance covered Km

Amount of gasoline used

Average fuel efficiency

(B)-2

After addition of the additive to the same car

Test Date: January, 23 to Feb. 12, 2004

Distance covered Km

Amount of gasoline used

Average fuel efficiency

Improvement degree of about 28.4%

Note that a new coolant was used instead of the old coolant and the additive was introduced thereinto.

(C)-1

Fuel efficiency tested car: Nissan Primera

Cylinder capacity

Place: Chiba

Test Date: May 8 to 17, 2004

Distance covered Km

Amount of gasoline used

Average fuel efficiency

(C)-2

After addition of the additive to the same car

Test Date: May 18 to 27, 2004

Distance covered Km

Amount of gasoline used

Average fuel efficiency

Improvement degree of about 26%

### [Overall Evaluations of the Additive]

### (1) Effect of Restraining Exhaust Gas After Introduction of the Additive

The certificate “Automobile Exhaust Gas Testing Results” (indicated in (A)-1 and (A)-2 above) on the additive has been received from JATA, MLTI Japan, a Japanese public organization. In Japan, the regulations of cleaning an exhaust gas are one of the severest ones in the world. However, the use of the additive further decreases the amounts of exhaust gases as compared with the amounts of the regulations, and has a large effect on fuel efficiency.

### (2) Effect of Decreasing Fuel After Introduction of the Additive

The amount of consumption of fuel largely depends on the conditions of a car. Although the additive had effects on a state-of-the-art hybrid car, a used car had large effects; particularly, the older a car, larger the effects. In a used car, the pressure and compression of the engine are worsen as the time elapses, and fuel efficiency also decreases. However, use of the additive allowed a used car to have engine conditions when it was brand-new or have effects more than its capacity.

### (3) Performance by Bodily Sensation After Introduction of the Additive

1. Engine noises considerably sensitively became quieter.

2. Number of revolutions of engine: The pointer of speed indicator rose

3. The power increased in a slope due to power increase.

4. Kickdown for response acceleration improved acceleration properties.

5. Temperature of cooling water was not particularly changed.

6. Odor within the car: Felt cool in the car. Odor specific to car was not felt.

7. Odor of exhaust gas: Black smoke disappeared and hardly noticed odor.

8. Blackness of exhaust gas: White cloth was placed over the exhaust gas pipe, but the cloth did not blacken much.

9. Effectiveness of air conditioner: The air conditioner was more effective.

10. Pushing of accelerator: Readily increased speed, and could have decided to be increased in power.

As discussed above, the introduction of a radiator additive according to the invention into a radiator causes negative ionization of a cooling water loaded into the radiator to proceed, and the step of circulating the cooling water around an engine combustion chamber negatively ionizes the engine combustion chamber. Entering a mixture gas of fuel and air in the negatively-ionized engine combustion chamber increases and activates the ionization degree of the mixture gas. This renders the mixture gas to be combusted and exploded in a substantially complete combustion state, thereby improving fuel efficiency and cleaning an exhaust gas.

What is claimed is:

1. A radiator additive comprising a composition of powders of a carbon-based semiconductor material and a negative ion ore (rare earth, radioactive ore and substance having radioactive capacity equivalent thereto) with a maximum particle size of the order of micrometers, and polypropylene glycol.

2. A radiator additive comprising a composition of a material produced by introducing a powder of a carbon-based semiconductor material with a particle size of the order of nanometers into water molecules to convert the mixture to a liquid, a powder of a negative ion ore (rare earth, radioactive ore and substance having radioactive capacity equivalent thereto) with a particle size of the order of micrometers, and polypropylene glycol.

3. The radiator additive according to claim 1 or 2, wherein the carbon-based semiconductor material is an inorganic germanium-carbon.

4. The radiator additive according to claim 1 or 2, wherein the negative ion ore comprises rare earth, radioactive ore and substance having radioactive capacity equivalent thereto, in particular, thorium ore.

5. The radiator additive according to claim 1 or 2, wherein the far-infrared emitting ore comprises pegmatite.

6. The radiator additive according to claim 1 or 2, wherein the negative ion ore comprises rare earth, radioactive ore and substance having radioactive capacity equivalent thereto, in particular, thorium ore, and
the far-infrared emitting ore comprises pegmatite.
